(19) United States
(12) Patent Application Publication
(10) Pub. No.: US 2020/0262486 A1
(43) Pub. Date: Aug. 20, 2020

(54) TRAILER FENDER WITH STORAGE AREA

(71) Applicant: KARAVAN TRAILERS, INC., Fox Lake, WI (US)

(72) Inventors: PATRIC SCHMIT, Randolph, WI (US); Joel Nehring, Randolph, WI (US); Joel McConville, Madison, WI (US)

(73) Assignee: KARAVAN TRAILERS, INC., Fox Lake, WI (US)

(21) Appl. No.: 16/793,322

(22) Filed: Feb. 18, 2020

Related U.S. Application Data
(60) Provisional application No. 62/807,029, filed on Feb. 18, 2019.

(51) Int. Cl. B62D 25/18; B60R 19/00; B60R 9/02

(52) U.S. Cl. CPC B62D 25/18; B60R 2019/002; B60R 9/02; B60R 19/00

(57) ABSTRACT

A trailer fender including at least one integrally formed, recessed storage well. The storage well may include a lockable cover. The cover may include a smooth or textured surface having a high coefficient of friction.

### RELATED APPLICATIONS

This application claims the benefit of Provisional Application No. 62/807,029 filed 18 Feb. 2019.

### BACKGROUND OF THE INVENTION

The present invention pertains to trailers intended to be towed by a motor vehicle. These trailers may be used for a variety of purposes including transporting boats, motorcycles, or other sports machines. Such trailers are generally made to transport the intended load without regard to other miscellaneous gear as may be required by the user. For example, a boater may also desire fishing tackle or other specialized gear. In these instances, miscellaneous gear must be stowed in the towing vehicle, or on the towed object itself. Such an arrangement may be inconvenient or the required space used may be needed for other objects. A new trailer feature is therefore desired which permits storage of gear or other objects on the trailer itself without the need to use valuable towing vehicle space. It is further desired to design a new trailer fender which includes integrally formed storage wells that may include a lockable cover.

### SUMMARY OF THE INVENTION

The invention provides a trailer including a novel fender. The new trailer fender includes at least one integrally formed, recessed storage well that may include a lockable cover. The surface of the covers may be textured for an added coefficient of friction. The fender may include a flat top surface, the top surface having curved ends wherein each curved end terminates in a respective flat distal portion. At least one of the top surface and the distal portions including a recessed well. The fender may further include at least one side portion extending normal to at least one distal portion, wherein the side portion includes a recessed area. The recessed area and the recessed well may include a cover, with the cover of the recessed well optionally including a locking mechanism. The cover of the recessed well may further include a surface having a high coefficient of friction.

### BRIEF DESCRIPTION OF THE DRAWINGS

FIG. 1 is a fragmentary perspective view of a trailer having a fender according to the present invention and having a plurality of storage wells.

FIG. 2 is a perspective view of the fender illustrated in FIG. 1.

FIG. 3 is a fragmentary view of the fender illustrated in FIGS. 1 and 2.

FIG. 4 is a perspective view of another fender according to the present invention and showing a pair of storage wells.

FIG. 5 is another view of the fender illustrated in FIG. 4.

FIG. 6A is a perspective view of the fender illustrated in FIG. 2, and showing covers on the storage wells.

FIG. 6B is a top view of the fender illustrated in FIG. 6A.

FIG. 6C is a side plan view of the fender illustrated in FIGS. 6A and 6B.

FIG. 6D is an enlarged top plan view of the area illustrated as 6D in FIG. 6B.

FIG. 6E is a cross sectional view of the fender illustrated in FIG. 6C and taken along lines 6E-6e thereof.

FIG. 7A is a rear perspective view of the fender illustrated in FIGS. 6A-6E, but showing a locking mechanism on the storage well covers.

FIG. 7B is an enlarged view of the area illustrated as 7B in FIG. 7A.

FIG. 7C is an enlarged view of the area illustrated as 7C in FIG. 7A.

FIG. 7D is an enlarged view of the area illustrated as 7D in FIG. 7A.

FIG. 8A is a perspective view of another embodiment of the fender according to the present invention and showing a pair of storage wells.

FIG. 8B is a top view of the fender illustrated in FIG. 8A.

FIG. 8C is a side plan view of the fender illustrated in FIGS. 8A and 8B.

FIG. 8D is an enlarged top plan view of the area illustrated as 8D in FIG. 8B.

FIG. 8E is a cross sectional view of the fender illustrated in FIG. 8C and taken along lines 8E-8e thereof.

FIG. 9A is a rear perspective view of the fender illustrated in FIGS. 8A-8E, but showing a locking mechanism on the storage well covers.

FIG. 9B is an enlarged view of the area illustrated as 9B in FIG. 9A.

FIG. 9C is an enlarged view, partially in phantom, of the area illustrated as 9D in FIG. 9A.

FIG. 10 is a fragmentary perspective view of a trailer having a fender according to the present invention, and similar to that of FIG. 1, but showing a fender having alternative covers and additional foot recesses.

FIG. 11 is another fragmentary perspective view of the trailer and fender illustrated in FIG. 10.

FIG. 12 is a perspective view of the fender illustrated in FIGS. 10 and 11.

FIG. 13 is another perspective view of the fender illustrated in FIGS. 10-12.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention which is defined by the claims.

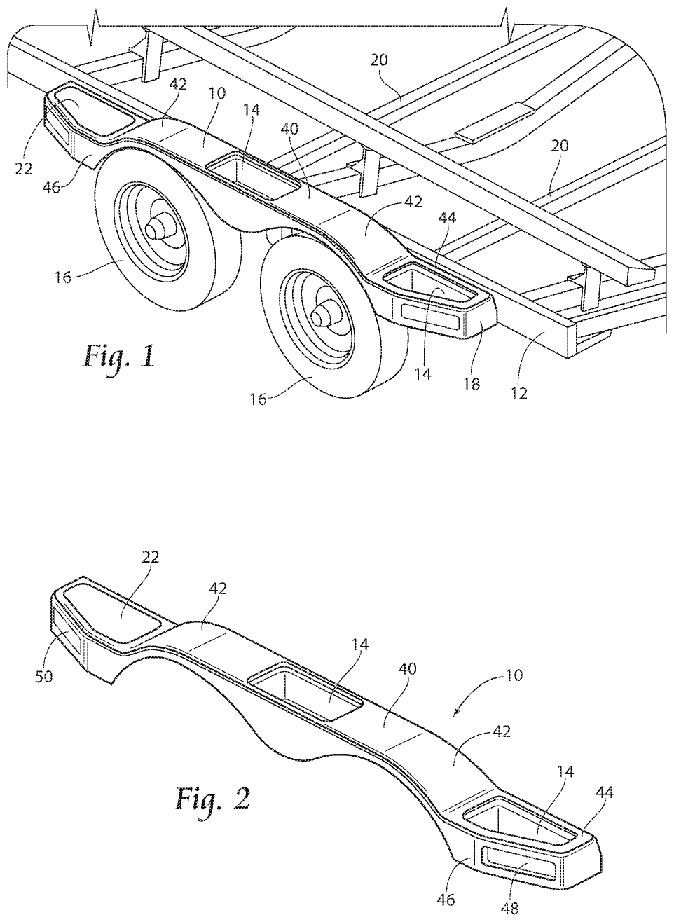

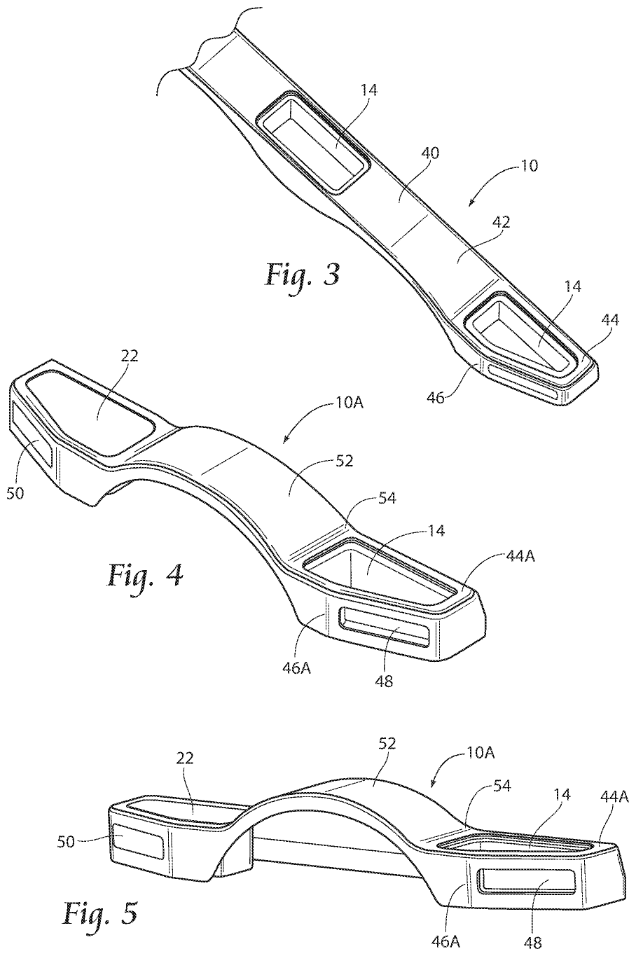

The invention is directed to a novel fender 10 for a trailer 12. As seen in FIG. 1, the trailer 12 may be boat trailer, or any other trailer for which fenders 10 according to the present invention may be desired. A fender 12 according to the present invention may be typically formed of plastic or other suitable material, and having at least one recessed, integrally formed, storage well 14, although any desired number of storage wells 14 is envisioned. With attention to FIGS. 2 and 3, the fender 10 may be seen to include three storage wells 14. For example, one well 14 may be located between the wheels 16 of the trailer 12 (see FIG. 1), and others located adjacent the forward and rear ends 18 of the fender 10. The arrangement of the recessed storage wells 14 shown in these views may be most useful when, for example, the trailer 12 on which the fender 10 is to be mounted utilizes two axles 20, and wherein each set of wheels 16 is spaced-apart from an adjacent one. As seen, the fender 10 includes a relatively flat top surface 40 having curved ends 42. Each curved end 42 terminates in a relatively flat distal portion 44. As shown, each of the top surface 40 and the distal portions 44 may preferably include a recessed storage well 14. As may be further seen, the fender 10 includes at least one side portion 46 extending normal to the distal portion 44. The side portion 46 may be smooth, or as seen in FIG. 2, may include a recessed area 48. The recessed area 48 may be adapted for use as a hand or foot hold, or may be provided with a cover 50 (see FIGS. 1 and 2) to contain objects (not shown). The recessed area 48 may be fitted with reflectors or lights (not shown) as desired.

In another arrangement, and as seen in FIGS. 4 and 5, the fender 10A may include a pair of storage wells 14. As may be viewed, in this arrangement the fender 10A is arranged for use on a trailer 12 having a single axle 20 (not shown in these views) in which each of the pair of storage wells 14 is located fore and aft of the trailer wheel 16. An arrangement such as this is preferably utilized in conjunction with a single axle 20 trailer 12 (not shown). As seen, the fender 10A includes a generally curved top surface 52 having ends 54, at least one of the ends 54 terminating in a relatively flat distal portion 44A. As shown, at least one of the distal portions 44A preferably includes a recessed storage well 14. As further seen, and similar to the fender 10 illustrated in FIGS. 1-3, the fender 10A in these views includes at least one side portion 46A extending normal to the distal portion 44A. The side portion 46A may be smooth, or as seen in FIGS. 4 and 5, may include a recessed area 48. The recessed area 48 may be adapted for use as a hand or foot hold, or may be provided with a cover 50 (see FIG. 4) to contain objects (not shown). The recessed area 48 may be fitted with reflectors or lights (not shown) as desired.

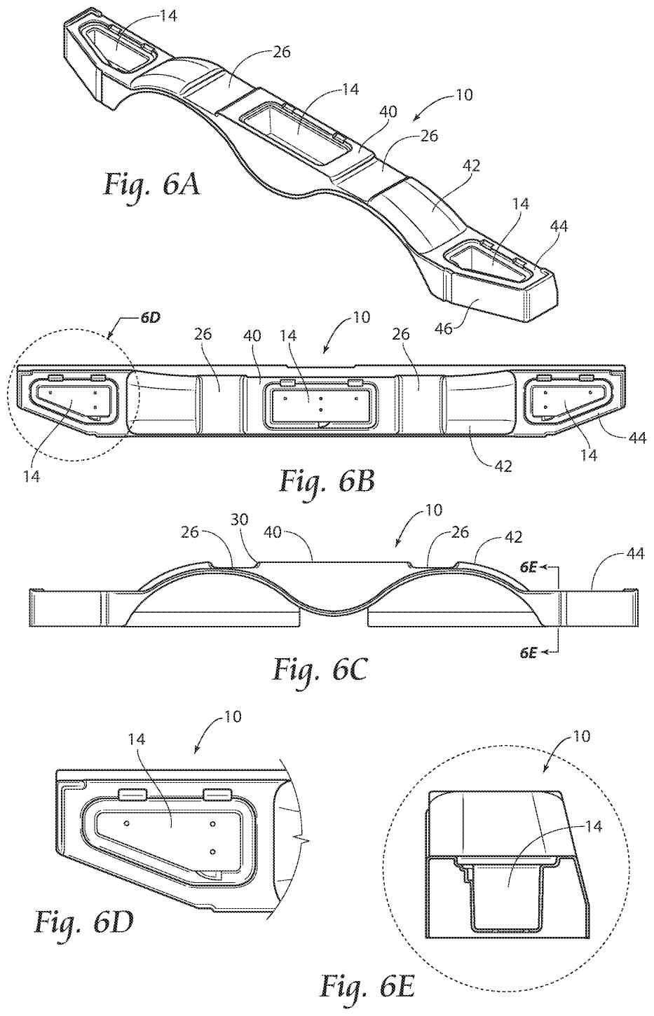

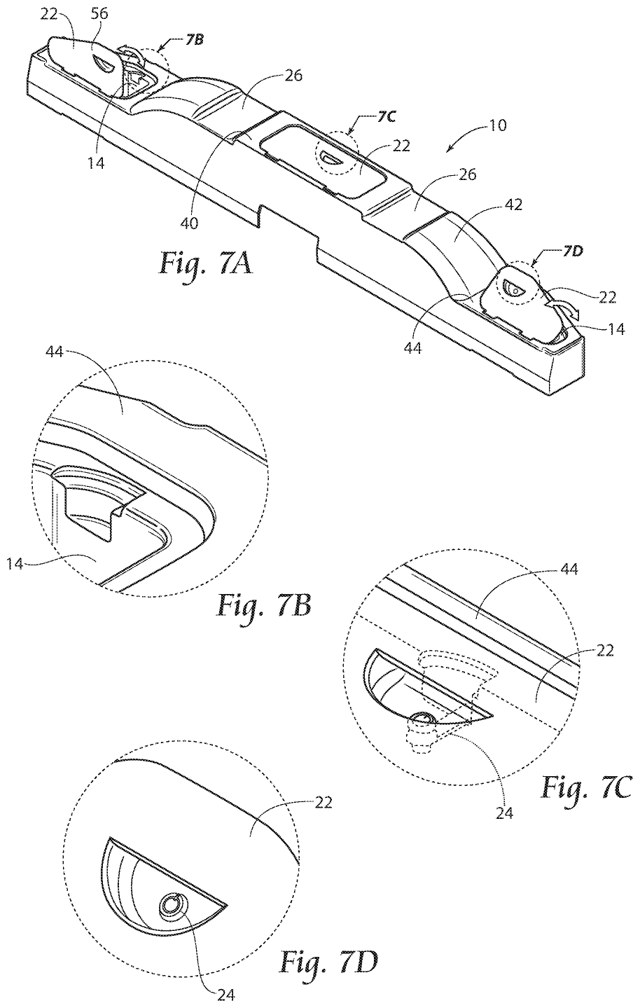

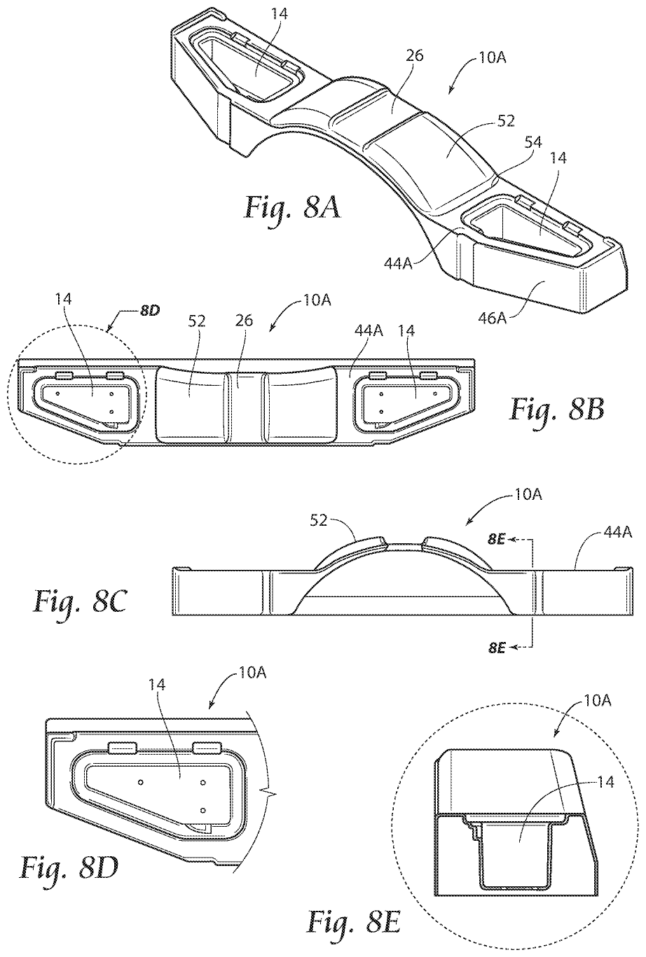

With attention now to FIGS. 6A-8E, it may be seen that the storage wells 14 may be further provided with covers 22, if desired. The covers 22 may be attached to the storage wells 14 by snap fit or other suitable means, or they may be rotatably attached, as seen in these views. As may be further seen, the covers 22 may include a locking mechanism 24 for added security of any contents (not shown) in the storage well 14. FIGS. 6A-8E illustrate an example of a locking mechanism 24 for use with the covers 22. Such a locking mechanism 24 is preferably flush with the cover 22 to minimize protrusions on the top surface 56 of the cover 22. When the covers 22 and locking mechanism 24 (if utilized) are flush with the surrounding surface of the fender 10, 10A the covers 22 may be used as a support or rest for the user (not shown) when climbing into or out of the trailer 12. It is to be understood that while a locking mechanism 24 is shown in the Figures, other locking structures for use on the cover 22 may be envisioned, such as levers, knobs, keys, or cams, by way of non-limiting example. Moreover, the arrangement, placement and number of storage wells 14 may be varied without departing from the invention.

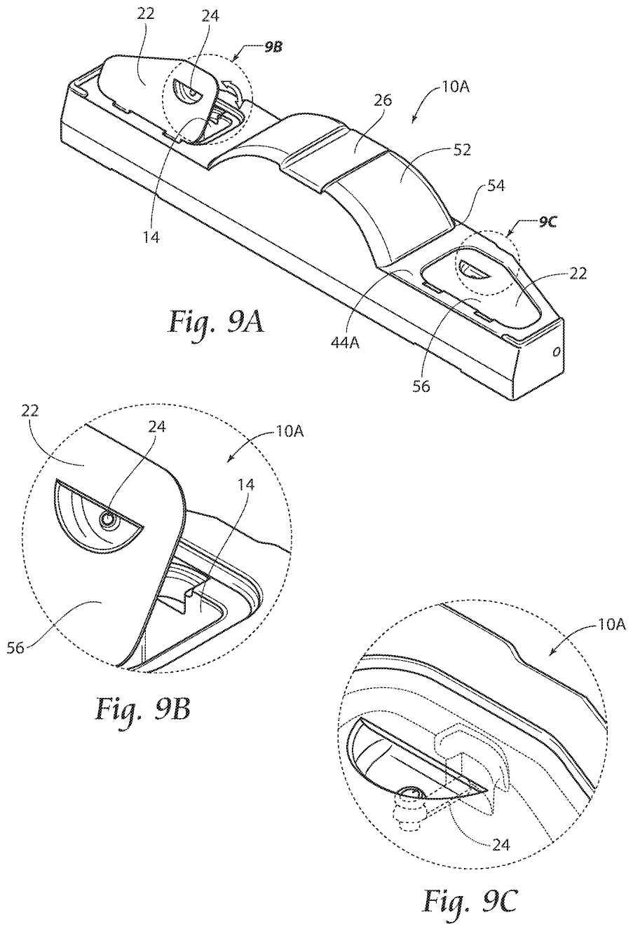

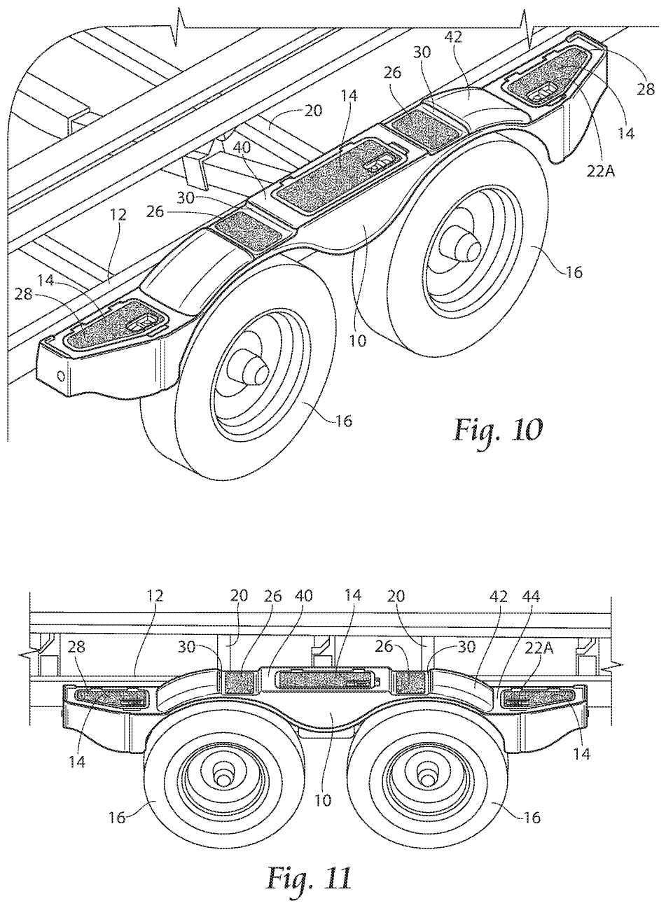

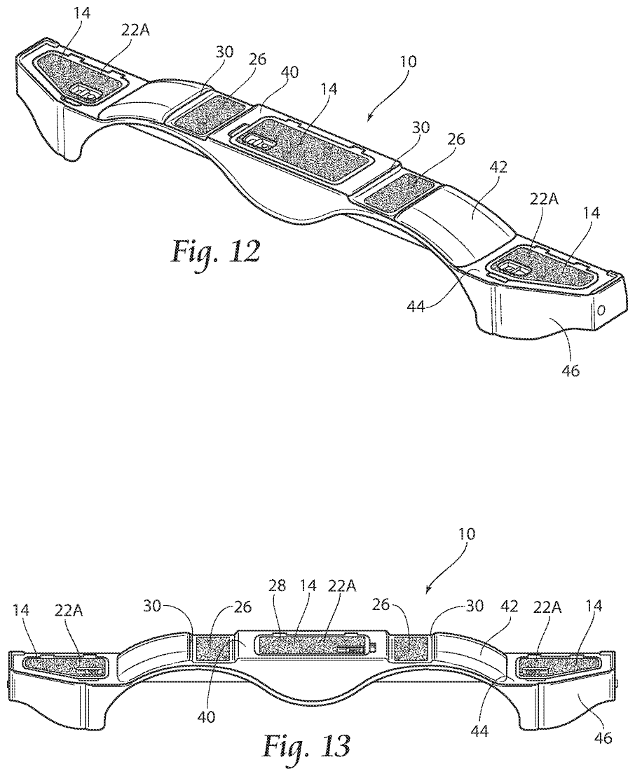

The top surface 56 of the covers 22 illustrated in FIGS. 1-8E may be relatively smooth, however, and as may be seen in FIGS. 10-13, the top surface 56 may be provided with a textured surface 28. A cover 22A having a textured surface 28 may be desirable in certain circumstances. For example, the textured surface 28 provides a high coefficient of friction which may enhance safety should the cover 22A be used as a foothold. The view of FIGS. 10-13 also show the top surface 40 of the fender having additional recessed sections 26. As is shown, the recessed sections 26 preferably include side ridges 30. The recessed sections 26 may also be used as a foothold if desired, with the side ridges 30 providing added security. Similar to the covers 22A, the recessed sections 26 may be furnished with a textured surface 28, as is illustrated in FIG. 10-13, or may be relatively smooth, as is seen in FIGS. 6A-9A.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention which is defined by the claims.

I/We claim:

1. A fender having a flat top surface, said top surface having curved ends wherein each curved end terminates in a respective flat distal portion, at least one of said top surface and said distal portion including a recessed well.

2. The fender of claim 1 further including at least one side portion extending normal to a distal portion, wherein said side portion includes a recessed area.

3. The fender of claim 2 wherein said recessed area includes a cover.

4. The fender of claim 1 wherein said recessed well includes a cover.

5. The fender of claim 4 wherein said cover includes a locking mechanism.

6. The fender of claim 4 wherein said cover includes a surface having a high coefficient of friction.

7. A fender having a curved top surface, the top surface having ends each terminating in a relatively flat distal portion, at least one of the distal portions including a recessed storage well.

8. The fender of claim 7 further including at least one side portion extending normal to a distal portion, wherein said side portion includes a recessed area.

9. The fender of claim 7 wherein said recessed storage well includes a cover.

10. The fender of claim 9 wherein said cover includes a locking mechanism.

11. The fender of claim 9 wherein said cover includes a surface having a high coefficient of friction.

12. The fender of claim 9 wherein said curved top surface further includes a recessed section.
